(19) United States
(12) Patent Application Publication
(10) Pub. No.: US 2024/0383086 A1
(43) Pub. Date: Nov. 21, 2024

(54) DEVICE FOR GEAR CUTTING, TOOL HEAD AND GEAR CUTTING MACHINE

(71) Applicant: Reishauer AG, Wallisellen (CH)

(72) Inventor: Michel MÜLLER, Uster (CH)

(73) Assignee: Reishauer AG, Wallisellen (CH)

(21) Appl. No.: 18/692,620

(22) PCT Filed: Sep. 2, 2022
(86) PCT No.: PCT/EP2022/074477

§ 371 Date: Mar. 15, 2024

(30) Foreign Application Priority Data
Sep. 16, 2021 (CH) 070280/2021

(51) Int. Cl. B23Q 5/04; B23B 31/30; B23B 31/40; B23F 5/04; B23F 23/12

(52) U.S. Cl. CPC B23Q 5/04; B23B 31/305; B23B 31/40; B23F 5/04; B23F 23/1275

(57) ABSTRACT

A device for machining a gear using a rotating machining tool. The device has a motor spindle having a drive motor and motor spindle shaft drivable by the drive motor for driving the machining tool. The device has an attachment structure for releasably attaching the device to a work spindle of a tool head. The attachment structure is configured so the tool axis is parallel to the work spindle axis when the device is attached to the work spindle. A device is further disclosed to connect a machining tool to a counter bearing in a simple manner. For this purpose, the counter bearing has a hollow shaft. A mandrel having first and second clamping regions are arranged at positions along the longitudinal axis of the mandrel. The mandrel is inserted through the hollow shaft along the tool axis into a longitudinal bore of the machining tool.

### TECHNICAL FIELD

The present invention relates to a device for machining a gear using a rotating machining tool, a tool head equipped therewith, and a gear cutting machine equipped therewith.

### PRIOR ART

In continuous generating gear grinding, a toothed workpiece is machined in generating engagement (a.k.a. rolling engagement) with a rotating grinding worm. The grinding worm is mounted on a tool head comprising a work spindle. At one end, the grinding worm is connected to the work spindle, which drives the grinding worm to rotate. A counter bearing may be provided at the other end of the grinding worm. However, a counter bearing is often dispensed with, particularly in the case of grinding worms that are relatively short in relation to their diameter. This makes it easier and faster to replace the grinding worm.

Recently, the object of machining gears having small module, such as those used in electric drives, has arisen more and more frequently. For this purpose, it can be useful to use relatively small but long grinding worms. A small grinding worm diameter may also be required for the machining of gears in which an interfering contour adjoins the gear axially. For small, long grinding worms, a one-sided bearing is disadvantageous, and the grinding worm should therefore be supported at both ends. The same applies to other small but long machining tools.

In the prior art, there are many examples of tool heads in which a machining tool is supported at both ends. In order to be able to exchange the machining tool despite the fact that it is supported at both ends, it has been proposed in the prior art to provide a permanently mounted drive spindle and a removable or movable counter bearing. An example with a movable counter bearing is given in EP0516596A1. However, such solutions can lead to disadvantages with regard to the positioning accuracy of the counter bearing and the rigidity of the tool head.

A further problem arises when a relatively small grinding worm is to be used on a gear cutting machine that was originally designed only for use with grinding worms of considerably larger diameter, having a correspondingly large work spindle and, if applicable, an equally large counter bearing. Collisions of the work spindle or the counter bearing with the workpiece can then occur. It is also possible that the tool interface of such a large work spindle is not suitable for connection to a small machining tool, or that the work spindle does not reach the desired speed.

EP2216118A2 discloses a device comprising a tool holder for a hobbing tool and a fastener for mounting in a milling head of a universal milling machine having at least five axes. A gearbox transmits rotational motion of a work spindle of the machine tool to the hobbing tool to drive the hobbing tool. In this way, an existing universal milling machine, which is not in itself designed for hobbing machining, can nevertheless be used to perform hobbing machining. However, the device has some disadvantages. For example, hobbing requires very precise synchronization of tool rotation with workpiece rotation. This requirement is difficult to meet with a gearbox. Secondly, the axis of rotation of the hobbing tool is perpendicular to the axis of rotation of the milling head. This arrangement is therefore not suitable for use in conventional gear cutting machines.

### SUMMARY OF THE INVENTION

In a first aspect, it is an object of the present invention to provide a device that enables a relatively small machining tool, in particular a machining tool for use in a generating method (a.k.a. a rolling machining tool), such as a grinding worm, to be used on a gear cutting machine whose tool head is not designed to directly receive such small machining tools.

This object is solved by a device having the features of claim 1. Further embodiments are defined in the dependent claims.

Thus, a device for machining a gear using a rotating machining tool having a first end and a second end is disclosed. The device comprises:
a motor spindle comprising a drive motor and a motor spindle shaft drivable by the drive motor, the motor spindle being configured to generate a rotation of the motor spindle shaft about a tool axis,
wherein the motor spindle shaft is configured to be connected to the machining tool at the first end thereof to drive the machining tool to rotate about the tool axis, using the drive motor,
an attachment structure for releasably attaching the device to a work spindle of a tool head, the work spindle being configured to generate a rotation of a work spindle shaft about a work spindle axis to drive a tool to rotate about the work spindle axis;
wherein the motor spindle is connected to the attachment structure, and
wherein the attachment structure is configured in such a manner that the tool axis is parallel to the work spindle axis when the device is attached to the work spindle of the tool head.

A device which is suitable for being connected to a work spindle of a tool head and which has a driven shaft, formed separately from the work spindle, for driving a machining tool is also referred to in the following as an “auxiliary spindle unit”. Since the auxiliary spindle unit according to the invention is configured to be connected to the work spindle of the tool head in such a way that the tool axis is parallel to the work spindle axis, essentially the same machining kinematics can be used for workpiece machining as would be used if the machining tool were clamped directly on the work spindle. By providing an independent motor spindle on the auxiliary spindle unit, the machining tool can be driven at the appropriate speed regardless of the limitations of the work spindle. In addition, if the machining tool is a machining tool for machining by a generating method, the presence of the motor spindle allows for more precise synchronization between the rotational movements of the machining tool and the workpiece than if the drive were to be provided from the work spindle via a gearbox or toothed belt drive.

In order to ensure that the tool axis runs parallel to the work spindle axis after the attachment of the auxiliary spindle unit to the work spindle, it is advantageous if the attachment structure has an at least partially annular (i.e. partially annular or completely annular) region which is configured to embrace the work spindle (in particular a housing region of the work spindle, wherein this housing region may be arranged adjacent to the tool interface of the work spindle), wherein the at least partially annular region defines an annular axis (ring axis) and this annular axis runs parallel to the tool axis. However, other designs of the attachment structure are also possible which ensure that the tool axis is parallel to the work spindle axis, e.g. a Hirth toothing, a circular arc toothing, a zero point clamping system or a conical connection between the auxiliary spindle unit and the work spindle. Accordingly, many different designs of the attachment structure are possible to ensure that the tool axis is parallel to the work spindle axis after the auxiliary spindle unit has been attached to the work spindle.

Particularly if the auxiliary spindle unit is to be used for machining by a generating method, it is advantageous if the auxiliary spindle unit also has a rotation measuring system for detecting a rotational position (rotational angle) of the spindle shaft about the tool axis. The rotational position of the spindle shaft detected in this way can be transmitted by the rotation measuring system to a machine controller, which establishes the necessary synchronization between the rotational movements of the machining tool and the workpiece for maintaining the rolling coupling.

The auxiliary spindle unit may be equipped with a balancing system, e.g. a single-or dual-plane balancing system. However, the auxiliary spindle can also be operated without a balancing system.

The auxiliary spindle unit may further comprise a counter bearing which is configured to rotatably mount the machining tool at its second end. This makes the auxiliary spindle unit particularly suitable for machining tools that are long in relation to their diameter.

To ensure good rigidity of the auxiliary spindle unit, it is advantageous if the motor spindle and the counter bearing are rigidly connected to the attachment structure.

In order to nevertheless be able to easily replace the machining tool, a design is particularly advantageous in which
the counter bearing has a hollow shaft which can be rotated around the tool axis,
the device has a mandrel (a.k.a. arbor) defining a longitudinal axis,
the mandrel has first and second clamping regions arranged at different positions along the longitudinal axis of the mandrel, and
the mandrel is insertable through the hollow shaft along the tool axis into a longitudinal bore of the machining tool, such that the first clamping region is capable of making a clamping connection with the hollow shaft of the counter bearing and the second clamping region is capable of making a clamping connection with the machining tool to thereby support the machining tool on the counter bearing.

The machining tool can be easily replaced with this design by loosening the clamping connections and retracting the mandrel in the hollow shaft of the counter bearing from the machining tool, thus enabling easy removal of the machining tool. At the same time, the use of a mandrel enables a particularly bend-resistant connection between the machining tool and the counter bearing.

Such a design is not only advantageous on an auxiliary spindle unit, but may also be employed on a tool head without an auxiliary spindle unit. In this respect, the invention also provides, in more general terms, a device for machining a gear using a rotating machining tool having a first end and a second end, comprising:
a motor spindle comprising a drive motor and a motor spindle shaft drivable by the drive motor and configured to be connected to the machining tool at the first end thereof to drive the machining tool to rotate about a tool axis;
a counter bearing configured to rotatably mount the rolling tool at the second end thereof, the counter bearing comprising a hollow shaft rotatable about the tool axis; and
a mandrel defining a longitudinal axis,
wherein the mandrel has first and second clamping regions arranged at different positions along the longitudinal axis of the mandrel, and
wherein the mandrel is insertable through the hollow shaft along the tool axis into a longitudinal bore of the machining tool such that the first clamping region is capable of making a clamping connection with the hollow shaft of the counter bearing and the second clamping portion is capable of making a clamping connection with the machining tool to thereby support the machining tool on the counter bearing.

This device may be designed as an actual tool head or, as described above, as an auxiliary spindle unit. If the device is designed as a tool head, the mentioned motor spindle is the work spindle of the tool head. It may then be mounted on a carrier together with the counter bearing. In particular, both the work spindle and the counter bearing may be rigidly mounted on the carrier. In particular, the carrier may be designed as a shifting slide, which in turn is displaceably arranged on a base body. The base body may be designed as a swivel body to be mounted on a tool carrier of a gear cutting machine so as to swivel.

Regardless of whether the device is configured as an actual tool head or as an auxiliary spindle unit, the mandrel may be configured to make the clamping connection in at least one of the two clamping regions in a force-fit by means of a clamping force acting radially outward. A force-fitted, radially acting connection compensates for the length tolerances of all parts. When different machining tools are mounted, any differences in length between the mounting flanges of these machining tools are irrelevant with this system. A purely radially acting force-fit connection ensures the connection axially and radially and does not lead to any undesirable axial distortions.

The two clamping regions may have identical or different outer diameters. In particular, the outer diameter of the first clamping region for connection to the hollow shaft of the counter bearing may be larger than the outer diameter of the second clamping region for connection to the machining tool.

The counter bearing may be without drive, or it may be part of a second motor spindle, with the help of which the machining tool can be driven on both sides.

In advantageous embodiments, the mandrel acts as a hydraulic expansion mandrel in at least one of the two clamping regions. A design in at least one of the clamping regions as a hydraulic expansion mandrel enables a secure connection between the machining tool and the counter bearing in a particularly simple manner. The functional principle of a hydraulic expansion mandrel is in itself known from the prior art. In particular, a hydraulic expansion mandrel comprises at least one expansion sleeve which delimits at least one clamping chamber and preferably several clamping chambers distributed in the longitudinal direction and/or circumferential direction radially outward. The clamping chambers can be pressurized hydraulically, whereby the expansion sleeve is expanded radially outward in the relevant clamping region to generate a clamping force acting radially outward. Preferably, the relevant clamping region has two axially spaced clamping points, at each of which at least one clamping chamber is arranged. In this way, optimum bending stiffness can be achieved.

Preferably, the mandrel acts as a hydraulic expansion mandrel in both clamping regions. For this purpose, one or more pressurizable clamping chambers are preferably provided in each of the two clamping regions.

Instead of a hydraulic expansion mandrel, however, the mandrel may also be designed as a mechanical mandrel. It is also possible to use a mandrel which is designed as a hydraulic expansion mandrel in the first clamping region, while it is designed as a mechanical mandrel in the second clamping region, or vice versa.

If the mandrel is designed as a mechanical mandrel in at least one of the two clamping regions, the mandrel may have a clamping sleeve in at least one of the two clamping regions which can be radially expanded by a mechanical action, similar to a hydraulic expansion mandrel. However, it is also possible for the mechanical mandrel to be designed to generate a clamping connection in the clamping region in question in a different way, for example by means of a clamping set known per se for a hollow shank taper connection. The clamping force generated in this way does not necessarily have to act radially outward.

If the mandrel is designed as a hydraulic expansion mandrel in at least one clamping region, the hydraulic expansion mandrel can be actuated mechanically or hydraulically in order to generate the hydraulic pressure in the hydraulic expansion mandrel with which the clamping connections are produced. If the hydraulic expansion mandrel is hydraulically actuated, the device may comprise a hydraulic rotary inlet in the region of the counter bearing to apply external hydraulic pressure to the hydraulic expansion mandrel. In this way, the clamping connections can be made and released in an externally controlled manner. In particular, this facilitates an automated tool change.

In order to further facilitate the tool change, the device may have an actuator which is configured to automatically insert the mandrel into the longitudinal bore of the machining tool along the tool axis in a state in which the first and second clamping connections are released, and to remove it from the longitudinal bore again. The actuator may be, for example, a hydraulic, pneumatic or electric actuator.

Of course, the device may further comprise the machining tool. In particular, the machining tool may comprise a machining tool for machining by a generating method, in particular a grinding worm or a gear hob. The machining tool is then preferably mounted on the motor spindle instead of on the work spindle, i.e., the first end of the machining tool is then connected to the motor spindle shaft to drive the machining tool for rotation about the tool axis.

The invention further provides a tool head comprising a work spindle and an auxiliary spindle unit of the type described above, wherein the attachment structure of the auxiliary spindle unit is connected to the work spindle such that the tool axis is parallel to the work spindle axis.

As already explained above, such a tool head may also comprise a base body and a shifting slide which can be displaced along a shift direction relative to the base body, the work spindle being arranged on the shifting slide.

Finally, the present invention also provides a gear cutting machine comprising a device of the type described above, at least one workpiece spindle for driving a workpiece to rotate about a workpiece axis, and a machine controller. The machine controller may then be configured to establish a rolling coupling between the rotation of the machining tool and the rotation of the workpiece.

### BRIEF DESCRIPTION OF THE DRAWINGS

Preferred embodiments of the invention are described below with reference to the drawings, which are for explanatory purposes only and are not to be construed restrictively. Shown in the drawings:

FIG. 1 a perspective view of an auxiliary spindle according to an embodiment;

FIG. 2 the auxiliary spindle of FIG. 1 in a vertical longitudinal section, the section plane containing the tool axis;

FIG. 3 a rolling tool in a central longitudinal section;

FIG. 4 a hydraulic expansion mandrel in a central longitudinal section;

FIG. 5 a tool head according to a first embodiment with the auxiliary spindle of FIG. 1;

FIG. 6 a machine tool with the tool head of FIG. 5;

FIG. 7 a tool head according to a second embodiment in a perspective view; and

FIG. 8 the tool head of FIG. 7 in a horizontal longitudinal section, the section plane containing the tool axis.

### DESCRIPTION OF PREFERRED EMBODIMENTS

### Auxiliary Spindle Unit

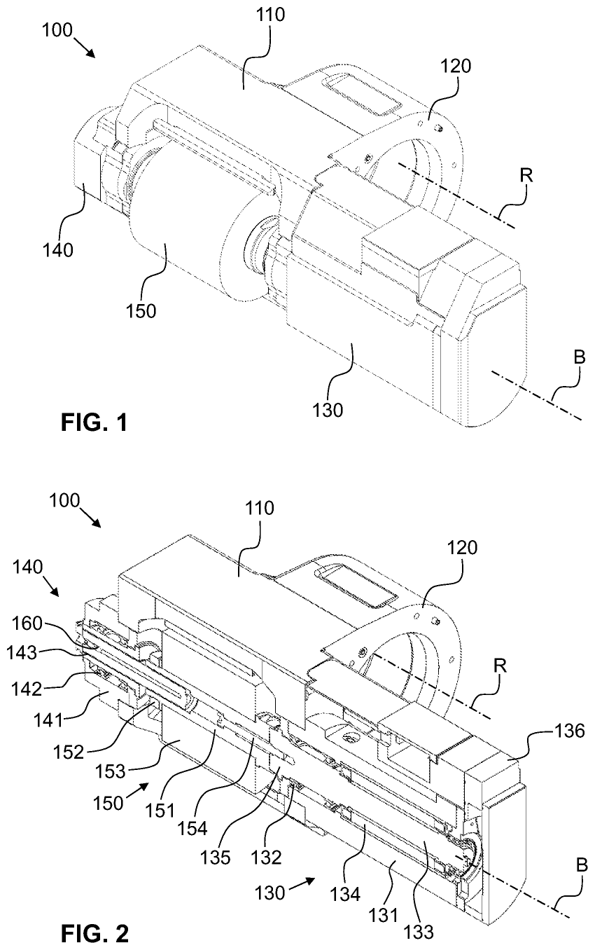

FIGS. 1 and 2 show an auxiliary spindle unit 100 according to an embodiment of the invention.

The auxiliary spindle unit 100 comprises a carrier 110 to which an attachment structure 120 is rigidly connected. The attachment structure 120 is used to attach the auxiliary spindle unit 100 to a work spindle of a tool head, as will be explained in more detail below. The attachment structure 120 is annular in shape, thereby defining an annular axis (ring axis) R that extends centrally through the annulus.

The auxiliary spindle unit 100 further comprises a motor spindle 130 and a counter bearing 140. The motor spindle 130 and the counter bearing 140 are each rigidly connected to the carrier 110. A tool 150 in the form of a grinding worm 150 is disposed between the motor spindle 130 and the counter bearing 140. The tool 150 is driven at one end by the motor spindle 130 to rotate about a tool axis B. At its other end, it is rotatably supported by the counter bearing 140. The tool axis B runs parallel to the ring axis R.

The motor spindle 130 is designed as a direct drive in a manner known per se. It has a housing 131 in which a total of four roller bearings 132 are accommodated. A spindle shaft 133 with tool interface 135 is rotatably mounted in the roller bearings 132. An electric drive motor 134 is used to drive the spindle shaft 133 directly. The roller bearings 132 are arranged on both sides of the drive motor 134 in a manner known per se. The two roller bearings located between the drive motor 134 and the tool interface 135 form an axial fixed bearing in a manner known per se, i.e. the region of the spindle shaft 133 located in these bearings and close to the tool interface 135 is axially fixed in these roller bearings with respect to the tool axis B. The other two roller bearings form an axial fixed bearing. The other two roller bearings form an axial floating bearing, i.e. the region of the spindle shaft 133 arranged in these bearings is axially movable to a certain extent with respect to these bearings. This serves in particular to allow thermal expansion of the spindle shaft. A rotation measuring system 136 serves to detect the rotational position of the spindle shaft 133 about the tool axis B.

The counter bearing 140 has a housing 141 in which two roller bearings 142 are received. A hollow shaft 143 is rotatably supported in the roller bearings 142. The two roller bearings 142 form an axial floating bearing for the hollow shaft 143, i.e. the hollow shaft 143 is movable to a certain extent along the tool axis B due to axial play of the two roller bearings 142.

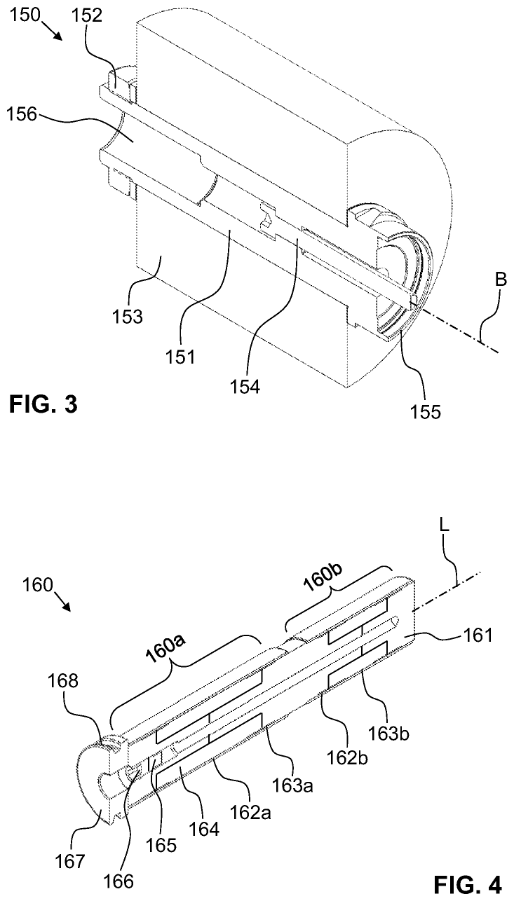

The tool 150 is shown alone in FIG. 3. It has a mounting flange 151 that supports a worm-shaped profiled grinding wheel 153. A precision shaft nut 152 fixes the grinding wheel 153 on the mounting flange 151. At its end facing the motor spindle 130, the mounting flange 151 has a short taper mounting 155, known per se, with a face contact in order to connect the mounting flange 151 centered to the tool interface 135 of the motor spindle 130. A complementary external taper with face contact is correspondingly formed on the tool interface 135. A threaded screw 154 serves to fix the mounting flange 151 axially to the tool interface 135. At its end facing the counter bearing 140, the mounting flange 151 has a central, cylindrical longitudinal bore 156.

Instead of a short taper connection fixed with a threaded screw, other types of connections between the mounting flange 151 and the tool interface 135 are also possible, as are sufficiently known from the prior art. In particular, it is possible to provide a hollow shank taper (HSK) connection or a Capto™ connection, as are widely used in mechanical engineering. In a manner known per se, the tool interface 135 may further comprise a clamping device, not shown, that can be fixed and released in a controlled manner to facilitate replacement of the machining tool 150. The threaded screw 135 can then be omitted accordingly.

A hydraulic expansion mandrel 160, which is shown alone in FIG. 4, is used to connect the mounting flange 151 to the counter bearing 140. The hydraulic expansion mandrel 160 has a cylindrical base body 161 in which a line system 164 for a hydraulic fluid is formed, which is only indicated schematically. The hydraulic expansion mandrel has two clamping regions 160a, 160b along its longitudinal axis L. In each of these clamping regions, the base body 161 is surrounded by a thin-walled expansion sleeve 162a, 162b. Each expansion sleeve 162a, 162b delimits a plurality of clamping chambers 163a, 163b radially outwardly. A clamping piston 165, which is axially displaceable by a clamping screw 166, is used to generate a hydraulic pressure which is transmitted to the clamping chambers 163a, 163b via the line system 164. As a result, the expansion sleeves 162a, 162b expand radially in the area of the clamping chambers 163a, 163b and thus establish radial clamping connections with the hollow shaft 143 of the counter bearing 140 and with the mounting flange 151 of the machining tool 150.

The axial positions at which the clamping chambers 163a, 163b are located are also referred to as clamping points. In the present example, the hydraulic expansion mandrel 160 has two clamping points in each of the two clamping regions 160a, 160b, for a total of four clamping points. This helps to achieve a high bending stiffness. However, it is also conceivable to provide only one clamping point in each of the two clamping regions 160a, 160b, for example.

While the two clamping regions 160a, 160b in the embodiment of FIG. 4 have the same outer diameter, these outer diameters can also be different. Specifically, the outer diameter of the first clamping region 160a can be selected larger than that of the second clamping region 160b. This can be particularly advantageous when using tools whose mounting flange has a longitudinal bore with a particularly small bore diameter. Within the clamping regions, the outside diameters can also vary in principle from clamping point to clamping point, in particular decreasing stepwise in the insertion direction.

At one end, the hydraulic expansion mandrel 160 protrudes axially from the counter bearing 140. At this end, the hydraulic expansion mandrel 160 has an end piece 167 with a circumferential annular groove 168, the function of which will be described in more detail below in connection with the second embodiment of a tool spindle.

To accommodate a machining tool 150 between the motor spindle 130 and the counter bearing 140, the hydraulic expansion mandrel 160 is first pulled completely out of the counter bearing 140, and the machining tool 150 is inserted between the motor spindle 130 and the counter bearing 140. The machining tool 150 is then connected to the tool interface 135 of the motor spindle 130. The attachment can be made through the counter bearing 140. Subsequently, the hydraulic expansion mandrel 160 is inserted axially through the hollow shaft 143 of the counter bearing 140 into the longitudinal bore 156 of the mounting flange 151, so that the first clamping region 160a of the hydraulic expansion mandrel 160 comes to lie within the hollow shaft 143 of the counter bearing 140, while the second clamping region 160b comes to lie within the longitudinal bore 156. The hydraulic expansion mandrel 160 is now radially clamped to the hollow shaft 143 of the counter bearing 140 and the mounting flange 151. To remove the machining tool 150 again, the procedure is reversed.

By using a hydraulic expansion mandrel 160 to connect the machining tool 150 to the counter bearing 140, a simple and at the same time flexurally rigid connection can be achieved even if the counter bearing 140 is rigidly connected to the carrier 110, i.e. if the counter bearing cannot be moved for the tool change. A counter bearing 140 that is rigidly connected to the carrier 110 has advantages in terms of rigidity compared to a movable counter bearing.

### First Embodiment of a Tool Head

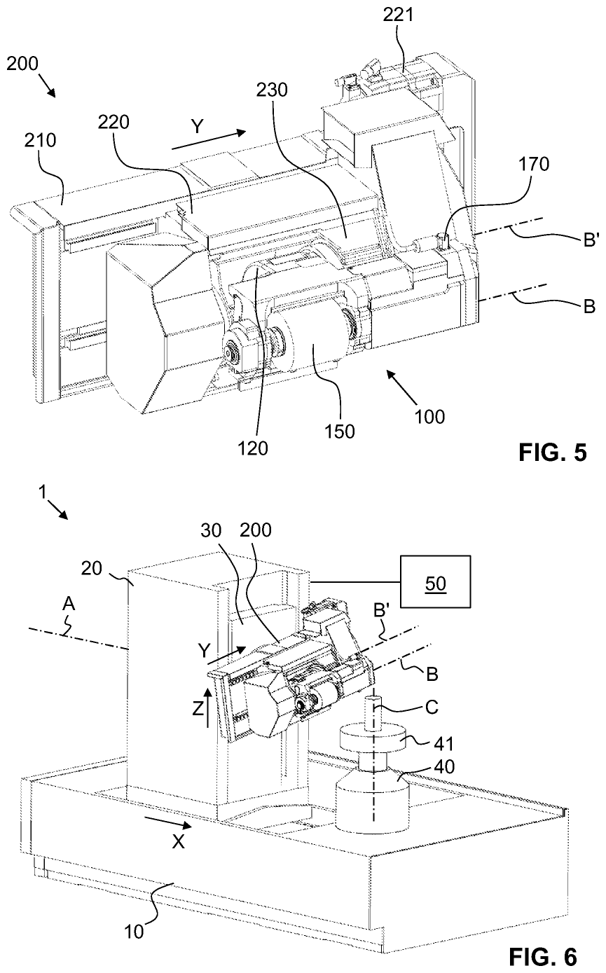

In FIG. 5, a tool head 200 according to a first embodiment is shown. The tool head comprises a base body 210, which is designed as a swivel body. A shifting slide 220 is arranged on the base body 210 so as to be displaceable along a shift direction Y. The shift direction Y runs parallel to the tool axis B. The shift direction Y runs parallel to the tool axis B. A Y-drive 221 is used for the controlled displacement of the shifting slide 220 on the base body 210.

A work spindle 230 is rigidly mounted on the shifting slide 220. In principle, it is possible to mount a machining tool directly on the work spindle 230 in order to drive it to rotate about a work spindle axis B′. For this purpose, the work spindle 230 has a suitable tool interface. However, direct clamping of the machining tool on the work spindle 230 is problematic if the tool has a small diameter, because collisions of a workpiece with the work spindle 230 can then easily occur.

In the present embodiment, therefore, the auxiliary spindle unit 100 described above is mounted on the work spindle 230. For this purpose, the attachment structure 120 of the auxiliary spindle unit 100 surrounds a front region of the housing of the work spindle 230, which is located adjacent to the tool interface of the work spindle 230, and thus fixes the auxiliary spindle unit 100 to the work spindle 230. As a result, the tool axis B runs parallel to and at a distance from the work spindle axis B′. A media interface 170, which is only indicated schematically, supplies the required media such as compressed air and electrical power to the auxiliary spindle unit 100, and measurement data can be exchanged with sensors of the auxiliary spindle unit 100.

The motor spindle 130 of the auxiliary spindle unit 100 can be made much more compact than the work spindle 230, which is arranged directly on the shifting slide 220, due to the small size of the machining tool 150 and the associated lower stock removal rate. The much more compact design of the motor spindle 130 of the auxiliary spindle unit 100 greatly reduces the risk of collision with a workpiece. At the same time, the motor spindle 130 and the counter bearing 140 can be specifically optimized for machining tasks with small machining tools. For example, the tool speed for a small machining tool may be considerably greater than for a larger machining tool, and accordingly the motor spindle 130 and the counter bearing 140 of the auxiliary spindle unit 100 may be designed for greater tool speeds than the work spindle 230 on the shifting slide 220.

FIG. 6 illustrates an example of a complete gear cutting machine 1 with the tool head 200 of the present first embodiment. The gear cutting machine 1 has a machine bed 10 on which a tool carrier 20 is arranged so as to be displaceable along a horizontal infeed direction X.

A Z-slide 30 is arranged on the tool carrier 20 so as to be displaceable along a vertical direction Z. The tool head 100 described above is arranged on the Z-slide 30, whereby the tool head 100 can be swivelled relative to the Z-slide 30 about a horizontal swivel axis A, which runs parallel to the feed direction X.

A workpiece spindle 40, on which a workpiece 41 is clamped, is also located on the machine bed 10. The workpiece spindle 40 can be driven to rotate about a workpiece axis C that runs parallel to the Z direction.

The machine also has a machine controller 50, which is shown only symbolically. The machine controller 50 takes over all control and monitoring tasks in the machine. In particular, the machine controller establishes the correct rolling coupling between the workpiece rotation about the workpiece axis C and the tool rotation about the tool axis B for machining the workpiece 41. For this purpose, it can receive and evaluate signals from the rotation measuring system 136 of the motor spindle 130 and from a rotation measuring system on the workpiece spindle 40.

The machine shown is to be understood as an example only, and the invention is of course not limited to this example. In particular, machine concepts are also conceivable in which two or more workpiece spindles are arranged on a movable carrier in order, for example, to be able to machine a workpiece on one of the workpiece spindles, while on the other workpiece spindle a machined workpiece is replaced by a blank and, if necessary, further operations are carried out. Such machine concepts are sufficiently known from the prior art.

### Second Embodiment of a Tool Head

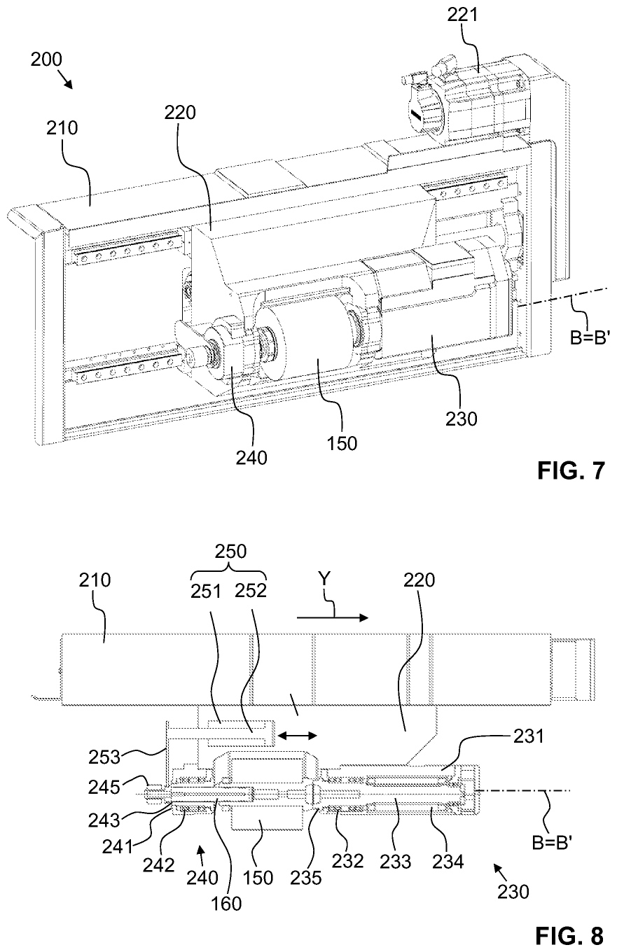

FIGS. 7 and 8 show a tool head 200 according to a second embodiment. In this embodiment, the tool head 200 comprises a carrier 210, a shifting slide 220, a Y-drive 221, a work spindle 230 rigidly connected to the shifting slide 220 and a counter bearing 240.

In contrast to the first embodiment, here the machining tool 150 is clamped directly on the work spindle 230 and supported in the counter bearing 240, i.e., no auxiliary spindle unit is used. However, the connection between the machining tool 150 and the counter bearing 240 is made in exactly the same way as the connection between the machining tool 150 and the counter bearing 140 in the first embodiment, namely by means of a hydraulic expansion mandrel 160.

Specifically, the counter bearing 240 includes a housing 241 in which two roller bearings 242 are retained, and in the roller bearings 242 in turn a hollow shaft 243 is mounted. As in the first embodiment, the hydraulic expansion mandrel 160 extends through the hollow shaft 243 into a longitudinal bore in the mounting flange of the machining tool 150 and establishes a radial clamping connection on the one hand with the hollow shaft 243 and on the other hand with the mounting flange.

In order to be able to automatically move the hydraulic expansion mandrel 160 into and out of the mounting flange, the tool head has a linear actuator 250, which in the present example is designed as a hydraulic cylinder 251 acting on both sides onto a hydraulic piston 252 displaceable therein. However, other types of actuators are of course also conceivable, for example a pneumatically or electrically actuated actuator. Connected to the hydraulic piston 252 is an actuating arm 253 which engages in the circumferential annular groove 168 in the end piece 167 of the hydraulic expansion mandrel 160 (cf. FIG. 4). Actuation of the actuator 250 thus moves the hydraulic expansion mandrel 160 axially.

In a further embodiment, the actuating arm 253 performs a dual function by additionally comprising a hydraulic line not shown in the drawing. In this way, hydraulic pressure can be applied to the hydraulic expansion mandrel 160 via a hydraulic rotary inlet 245 in order to establish or release the clamping connection in a controlled manner. The clamping screw 166 and, if necessary, also the clamping piston 165 can be omitted in such a further embodiment. Overall, a fully automatic tool change can be realized in this way, without manual intervention on the hydraulic expansion mandrel 160.

For the sake of completeness, the design of the work spindle 230 is also briefly explained below. It has a housing 231 in which several roller bearings 232 are arranged. A work spindle shaft 233 is mounted in the roller bearings 232 so that it can rotate about the work spindle axis B′ and can be driven directly by a drive motor 234. A tool interface 235, which is indicated here only in a highly schematic manner, serves for connection with the mounting flange of the tool 150. As was already indicated in connection with the first embodiment, the tool interface 235 can be designed in any manner known per se, e.g. as an HSK connection according to ISO 12164-1:2001-12, as a steep taper connection according to DIN ISO 7388-1 & 2:2014-07 or as a Capto™ connection according to ISO 26623-1:2020. In this embodiment, the tool axis B coincides with the work spindle axis B′.

### Modifications

It is apparent from the foregoing that a variety of variations are possible without departing from the scope of the invention as defined in the claims.

In particular, the invention can be used not only with tools for machining by a generating process such as grinding worms or gear hobs, but also with machining tools comprising at least one profile grinding wheel, including combination tools comprising at least one grinding worm on a common tool mandrel with at least one profile grinding wheel. The tool may in particular also be a polishing tool, e.g. a polishing grinding worm, or a combination tool with a polishing grinding area.

An actuator as in the second embodiment may of course also be provided in an auxiliary spindle unit according to the first embodiment. The same applies to the hydraulic rotary inlet discussed above.

While in the embodiments described above it is not provided that the tool is additionally driven on the side of the respective counter bearing 140, 240, the counter bearing may also be part of a second motor spindle to drive the tool on both sides.

LIST OF REFERENCE SIGNS

| | |
|---|---|
| 1 | Gear cutting machine |
| 10 | Machine bed |
| 20 | Tool carrier |
| 30 | Z slide |
| 40 | Workpiece spindle |
| 41 | Workpiece |
| 50 | Machine controller |
| 100 | Auxiliary spindle unit |
| 110 | Carrier |
| 120 | Attachment structure |
| 130 | Motor spindle |
| 131 | Housing |
| 132 | Roller bearing |
| 133 | Spindle shaft |
| 134 | Drive motor |
| 135 | Tool interface |
| 136 | Rotation measuring system |
| 140 | Counter bearing |
| 141 | Housing |
| 142 | Roller bearing |
| 143 | Hollow shaft |
| 150 | Machining tool |
| 151 | Mounting flange |
| 152 | Precision shaft nut |
| 153 | Grinding wheel |
| 154 | Threaded screw |
| 155 | Short taper mounting |
| 156 | Longitudinal bore |
| 160 | Hydro expansion mandrel |
| 160a | first clamping region |
| 160b | second clamping region |
| 162a, 162b | Expansion sleeve |
| 163a, 163b | Clamping chamber |
| 164 | Line system |
| 165 | Clamping piston |
| 166 | Clamping screw |
| 167 | End piece |
| 168 | Annular groove |
| 170 | Media interface |
| 200 | Tool head |
| 210 | Basic body |
| 220 | Shifting slide |
| 221 | Shift drive |
| 230 | Work spindle |
| 231 | Housing |
| 232 | Roller bearing |
| 233 | Spindle shaft |
| 234 | Drive motor |
| 235 | Tool interface |
| 240 | Counter bearing |
| 241 | Housing |
| 242 | Roller bearing |
| 243 | Hollow shaft |
| 245 | Rotary inlet |
| 250 | Actuator |
| 251 | Hydraulic cylinder |
| 252 | Hydraulic piston |
| 253 | Actuating arm |
| A | Swivel axis |
| B | Tool axis |
| B′ | Work spindle axis |
| C | Workpiece axis |
| R | Annular axis |
| X, Y, Z | Directions |

1. A device for machining a gear using a rotating machining tool having a first end and a second end, the device comprising:
a motor spindle having a drive motor and a motor spindle shaft drivable by the drive motor, the motor spindle being configured to generate a rotation of the motor spindle shaft about a tool axis, wherein the motor spindle shaft is configured to be connected to the machining tool at the first end thereof for driving the machining tool to rotate about the tool axis,
wherein the device is configured as an auxiliary spindle unit for releasable attachment to a work spindle of a tool head, the work spindle being configured to generate a rotation of a work spindle shaft about a work spindle axis to drive the machining tool or another tool to rotate about the work spindle axis,
wherein the device comprises an attachment structure configured for releasably attaching the device to the work spindle,
wherein the motor spindle is connected to the attachment structure, and
wherein the attachment structure is configured such that the tool axis is parallel to the work spindle axis when the device is attached to the work spindle of the tool head.

2. The device according to claim 1, wherein the attachment structure comprises an at least partially annular region configured to embrace the work spindle, the at least partially annular region defining an annular axis, the annular axis being parallel to said tool axis.

3. The device according to claim 1, further comprising a rotation measuring system for detecting a rotational position of the motor spindle shaft about the tool axis.

4. The device according to claim 1, further comprising a counter bearing configured to rotatably support the machining tool at the second end thereof.

5. The device according to claim 4, wherein the motor spindle and the counter bearing are rigidly connected to the attachment structure.

6. The device according to claim 4,
wherein the counter bearing comprises a hollow shaft which is rotatable about the tool axis,
wherein the device comprises a mandrel defining a longitudinal axis,
wherein the mandrel comprises first and second clamping regions arranged at different positions along the longitudinal axis of the mandrel, and wherein the mandrel is insertable through the hollow shaft along the tool axis into a longitudinal bore of the machining tool such that the first clamping region is capable of making a clamping connection with the hollow shaft of the counter bearing and the second clamping region is capable of making a clamping connection with the machining tool so as to support the machining tool in the counter bearing.

7. A device for machining a gear using a rotating machining tool having a first end and a second end, the device comprising:
a motor spindle having a drive motor and a motor spindle shaft drivable by the drive motor, the motor spindle shaft being configured to be connected to the machining tool at the first end thereof to drive the machining tool to rotate about a tool axis; and
a counter bearing configured to rotatably support the machining tool at its second end,
the counter bearing comprising a hollow shaft being rotatable about the tool axis; and
a mandrel defining a longitudinal axis,
wherein the mandrel comprises first and second clamping regions arranged at different positions along the longitudinal axis of the mandrel, and
wherein the mandrel is insertable through the hollow shaft along the tool axis into a longitudinal bore of the machining tool such that the first clamping region is capable of making a clamping connection with the hollow shaft of the counter bearing and the second clamping region is capable of making a clamping connection with the machining tool so as to support the machining tool in the counter bearing.

8. The device according to claim 7, wherein the first and/or second clamping region is configured to establish a radially outwardly directed clamping connection.

9. The device according to claim 8, wherein the mandrel in the first and/or second clamping region is configured as a hydraulic expansion mandrel.

10. The device according to claim 9, wherein the device comprises a hydraulic rotary inlet in the region of the counter bearing for applying an external hydraulic pressure to the hydraulic expansion mandrel.

11. The device according to claim 7, further comprising an actuator being configured to automatically insert the mandrel into the longitudinal bore of the machining tool along the tool axis in a state in which the first and second clamping connections are released, and to remove the mandrel out of the longitudinal bore again.

12. The device according to claim 7, further comprising the machining tool, wherein the first end of the machining tool is connected to the motor spindle shaft to drive the machining tool for rotation about the tool axis.

13. The device according to claim 12, wherein the machining tool comprises a grinding worm.

14. A tool head, comprising:
a work spindle; and
a device according to claim 1,
wherein the attachment structure is connected to the work spindle such that the tool axis is parallel to the work spindle axis.

15. The tool head according to claim 14, further comprising:
a base body; and
a shifting slide that is displaceable along a shift direction relative to the base body,
wherein the work spindle is arranged on the shifting slide.

16. A gear cutting machine, comprising:
the device according to claim 1;
at least one workpiece spindle for driving a workpiece to rotate about a workpiece axis; and
a machine controller,
wherein the machine controller is configured to establish a rolling coupling between the rotation of the machining tool and the rotation of the workpiece.

17. The device according to claim 1, further comprising the machining tool, wherein the first end of the machining tool is connected to the motor spindle shaft to drive the machining tool for rotation about the tool axis.

18. The device according to claim 17, wherein the machining tool comprises a grinding worm.

19. A gear cutting machine, comprising:
the device according to claim 7;
at least one workpiece spindle for driving a workpiece to rotate about a workpiece axis; and
a machine controller,
wherein the machine controller is configured to establish a rolling coupling between the rotation of the machining tool and the rotation of the workpiece.
